(19) United States
(12) Patent Application Publication
(10) Pub. No.: US 2025/0029996 A1
(43) Pub. Date: Jan. 23, 2025

(54) BATTERY

(71) Applicant: ZHUHAI COSMX BATTERY CO., LTD., Zhuhai (CN)

(72) Inventors: Changan ZENG, Zhuhai (CN); Hai WANG, Zhuhai (CN); Suli LI, Zhuhai (CN); Junyi LI, Zhuhai (CN)

(73) Assignee: ZHUHAI COSMX BATTERY CO., LTD., Zhuhai (CN)

(21) Appl. No.: 18/901,519

(22) Filed: Sep. 30, 2024

Related U.S. Application Data
(63) Continuation of application No. PCT/CN2023/125225, filed on Oct. 18, 2023.

(30) Foreign Application Priority Data
Nov. 18, 2022 (CN) 202211449329.7

(51) Int. Cl. H01M 4/525; H01M 4/02; H01M 10/0567

(52) U.S. Cl. CPC H01M 4/525; H01M 10/0567; H01M 2004/021; H01M 2004/028

(57) ABSTRACT

A battery includes a positive electrode material with a complete crystalline structure. The positive electrode material meets 1.3≤I₀₀₃/I₁₀₄≤3, 0.02≤I₀₀₆/I₀₀₃≤0.15, and 0.06≤I₀₀₆/I₁₀₄≤0.15. The battery further includes an electrolyte solution, the electrolyte solution includes a first additive, the first additive includes a nitrile compound, and the electrolyte solution meets the following relational expression: 3%≤B≤6%, where B is a percentage of a mass of the nitrile compound in a total mass of the electrolyte solution. The positive electrode material has high thermal stability, which is conducive to improving a hot box pass rate of the battery and improving high temperature storage performance and cycling performance of the battery.

### CROSS-REFERENCE TO RELATED APPLICATIONS

The present disclosure is a continuation of International Application No. PCT/CN2023/125225 filed on Oct. 18, 2023, which claims priority to Chinese Patent Application No. 202211449329.7, filed on Nov. 18, 2022. All of the aforementioned patent applications are hereby incorporated by reference in their entireties.

### TECHNICAL FIELD

The present disclosure pertains to the field of lithium-ion battery technologies, and in particular, to a lithium-ion battery including a positive electrode material with a complete crystalline structure and an electrolyte solution.

### BACKGROUND

Since lithium-ion batteries have been commercialized, they are widely used in fields such as digital field, energy storage, power, military aerospace, and communications devices because of their advantages such as lightness and convenience, high specific energy, memory-free effect, and good cycling performance. With widespread application of lithium-ion batteries, consumers impose higher requirements on performance such as energy density, cycle life, high temperature performance, and safety of lithium-ion batteries.

As people's living standards get increasingly high, increasingly high requirements are imposed on energy density and safety performance of batteries. On the one hand, energy density may be increased by increasing a voltage of a positive electrode, and on the other hand, a negative electrode with a higher capacity per gram may be used, for example, a silicon negative electrode is introduced. However, increasing the voltage of the positive electrode may lead to problems such as deterioration of high temperature cycling performance of batteries, deterioration of the stability of a positive electrode interface, and deterioration of safety performance of a hot box.

### SUMMARY

To improve a problem that high temperature cycling performance of a battery deteriorates and a heat box pass rate is low due to oxidation and decomposition of an electrolyte solution at a high voltage and deterioration of the stability of a positive electrode interface, the present disclosure provides a battery. Through optimization of a crystalline structure (for example, a ratio of peak intensity of XRD characteristic diffraction peaks of a positive electrode material) of a positive electrode material in a positive electrode plate of the battery and composition of an electrolyte solution, normal temperature storage performance, cycling performance, and a hot box pass rate of the battery can be significantly improved.

The present disclosure is implemented by using the following technical solution.

A battery includes a positive electrode plate, the positive electrode plate includes a positive electrode material, and the positive electrode material meets the following relationships:

$$1.3 \leq {I}_{003} / {I}_{104} \leq 3 , 0.02 \leq {I}_{006} / {I}_{003} \leq 0.15 , and 0.06 \leq {I}_{006} / {I}_{104} \leq 0.15 ,$$

where I₀₀₃ is intensity of a characteristic diffraction peak of a (003) crystal plane that is obtained from an XRD diffraction peak of a powder sample of the positive electrode material, I₁₀₄ is intensity of a characteristic diffraction peak of a (104) crystal plane that is obtained from the XRD diffraction peak of the powder sample of the positive electrode material, and I₀₀₆ is intensity of a characteristic diffraction peak of a (006) crystal plane that is obtained from the XRD diffraction peak of the powder sample of the positive electrode material.

The battery includes an electrolyte solution, the electrolyte solution includes a first additive, the first additive includes a nitrile compound, and the electrolyte solution meets the following relational expression:

$$3 \% \leq B \leq 6 \% ,$$

where B is a percentage of a mass of the nitrile compound in a total mass of the electrolyte solution.

According to an implementation of the present disclosure, the electrolyte solution further includes a second additive, and the second additive includes at least one of compounds shown in Formula 1:

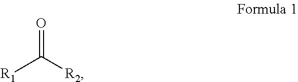

where R₁ and R₂ are the same or different, and are independently selected from a 5- to 12-membered heteroaromatic group.

Beneficial effects of the present disclosure are as follows.

A battery is disclosed in the present disclosure. The battery includes a positive electrode material with a complete crystalline structure. The positive electrode material meets 1.3≤I₀₀₃/I₁₀₄≤3, 0.02≤I₀₀₆/I₀₀₃≤0.15, and 0.06≤I₀₀₆/I₁₀₄≤0.15, which indicates that the positive electrode material has high crystallization integrity, a layered structure thereof has good stability, and a high degree of order is achieved in terms of the ion arrangement of cations (lithium ions and cobalt ions). The positive electrode material has high thermal stability, which is conducive to improving a hot box pass rate of the battery. Moreover, the positive electrode material has high structural stability and a relatively stable interface under high-voltage and full-electricity conditions, which is conducive to improving high temperature storage performance and normal temperature and high temperature cycling performance of the battery. Based on this, in combination with an electrolyte solution containing a nitrile compound, especially an electrolyte solution containing adiponitrile, the nitrile compound can be bonded to high-valence cobalt ions on a positive electrode interface, thereby reducing an oxidative catalytic effect of the high-valence cobalt ions on the electrolyte solution. This helps improve a hot box pass rate of the battery. In addition, an amount of added nitrile compounds is controlled, so that the nitrile compounds can better protect the positive electrode interface, reduce interface impedance while stabilizing transition metal ions on the interface, and facilitate deintercalation of lithium ions, thereby improving normal temperature and high temperature cycling performance and high temperature storage performance of the battery, and reducing a failure risk caused by Joule heat caused by a safety test such as a hot box.

Further, through addition of the second additive, stable low-impedance SEI films can be simultaneously formed on both the positive electrode interface and a negative electrode interface, the stability of the positive electrode interface and the negative electrode interface is improved, the dissolution of transition metal ions is reduced, oxidative decomposition of the electrolyte solution by high-valence cobalt is reduced, damage caused by the dissolution of transition metal ions to the SEI film on the negative electrode is reduced, heat generated by redox is reduced, and Joule heat is reduced. Therefore, high temperature storage performance, cycling performance, and safety performance of the battery are improved.

Further, the battery has excellent high temperature storage performance, cycling performance, and hot box safety performance through a synergistic effect between the positive electrode material and composition of the electrolyte solution in the battery.

### BRIEF DESCRIPTION OF THE DRAWINGS

FIG. 1 shows an XRD spectra of positive electrode materials in Comparative Example 1.

FIG. 2 shows an XRD spectra of positive electrode materials in Example 1.

### DETAILED DESCRIPTION OF THE EMBODIMENTS

The following further describes in detail the present disclosure with reference to specific examples. It should be understood that the following examples are merely for example descriptions and intended to explain the present disclosure and shall not be construed as a limitation on the protection scope of the present disclosure. All technologies achieved based on the foregoing content of the present disclosure are included in the protection scope of the present disclosure.

The present disclosure is implemented by using the following technical solution.

A battery includes a positive electrode plate, the positive electrode plate includes a positive electrode material, and the positive electrode material meets the following relationships:

$$1.3 \leq {I}_{003} / {I}_{104} \leq 3 , 0.02 \leq {I}_{006} / {I}_{003} \leq 0.15 , and 0.06 \leq {I}_{006} / {I}_{104} \leq 0.15 ,$$

where I₀₀₃ is intensity of a characteristic diffraction peak of a (003) crystal plane that is obtained from an XRD diffraction peak of a powder sample of the positive electrode material, I₁₀₄ is intensity of a characteristic diffraction peak of a (104) crystal plane that is obtained from the XRD diffraction peak of the powder sample of the positive electrode material, and I₀₀₆ is intensity of a characteristic diffraction peak of a (006) crystal plane that is obtained from the XRD diffraction peak of the powder sample of the positive electrode material.

In some implementations, after an XRD diffraction ray test, a characteristic peak of the (003) crystal plane of the powder sample of the positive electrode material appears at an angle of 2θ=18° to 20°, a characteristic peak of the (104) crystal plane appears at an angle of 2θ=44° to 46°, and a characteristic peak of the (006) crystal plane appears at an angle of 2θ=38° to 40°.

In some preferred implementations, the positive electrode material meets the following relationships:

$$1.6 \leq {I}_{003} / {I}_{104} \leq 3 , 0.055 \leq {I}_{006} / {I}_{003} \leq 0.15 , and 0.1 \leq {I}_{006} / {I}_{104} \leq 0.15 .$$

Intensity of characteristic diffraction peaks of the (003) crystal plane, the (104) crystal plane, and the (006) crystal plane of the powder sample of the positive electrode material falls within the foregoing preferred range, so that normal temperature storage performance, cycling performance, and a hot box pass rate of the battery can be significantly improved.

The battery includes an electrolyte solution, the electrolyte solution includes a first additive, the first additive includes a nitrile compound, and the electrolyte solution meets the following relational expression:

$$3 \% \leq B \leq 6 \% ,$$

where B is a percentage of a mass of the nitrile compound in a total mass of the electrolyte solution.

When the percentage of the mass of the nitrile compound in the total mass of the electrolyte solution falls within the foregoing range, the nitrile compound can better protect a positive electrode interface, reduce interface impedance while stabilizing transition metal ions on the interface, and facilitate deintercalation of lithium ions, thereby improving normal temperature and high temperature cycling performance and high temperature storage performance of the battery, and reducing a failure risk caused by Joule heat caused by a safety test such as a hot box.

According to an implementation of the present disclosure, B may be 3%, 3.2%, 3.5%, 4%, 4.5%, 5%, 5.5%, or 6%.

According to an implementation of the present disclosure, I₀₀₃/I₁₀₄ may be 1.3, 1.4, 1.5, 1.6, 1.7, 1.8, 1.9, 2.0, 2.1, 2.2, 2.3, 2.4, 2.5, 2.6, 2.7, 2.8, 2.9, or 3.

According to an implementation of the present disclosure, I₀₀₆/I₀₀₃ may be 0.02, 0.03, 0.04, 0.05, 0.06, 0.07, 0.08, 0.09, 0.10, 0.11, 0.12, 0.13, 0.14, or 0.15.

According to an implementation of the present disclosure, I₀₀₆/I₁₀₄ may be 0.06, 0.07, 0.08, 0.09, 0.10, 0.11, 0.12, 0.13, 0.14, or 0.15.

It is found through research that, when the intensity of the characteristic diffraction peak of the (003) crystal plane that is obtained from the XRD diffraction peak of the powder sample of the positive electrode material, the intensity of the characteristic diffraction peak of the (104) crystal plane, and the intensity of the characteristic diffraction peak of the (006) crystal plane meet 1.3≤I₀₀₃/I₁₀₄≤3, 0.02≤I₀₀₆/I₀₀₃≤0.15, and 0.06≤I₀₀₆/I₁₀₄≤0.15, it indicates that the positive electrode material has high crystallization integrity, a layered structure thereof has good stability, and a high degree of order is achieved in terms of the ion arrangement of cations (lithium ions and cobalt ions). The positive electrode material has high thermal stability, which is conducive to improving a hot box pass rate of the battery. Moreover, the positive electrode material has high structural stability and a relatively stable interface under high-voltage and full-electricity conditions, which is conducive to improving high temperature storage performance and normal temperature and high temperature cycling performance of the battery.

According to an implementation of the present disclosure, the positive electrode material is a positive electrode material doped and/or coated with modified lithium cobalt oxide. By doping and/or coating lithium cobalt oxide, the lithium cobalt oxide can be modified to improve the structural stability of the positive electrode material.

According to an implementation of the present disclosure, Dv50 of the positive electrode material ranges from 12 μm to 20 μm, for example, is 12 μm, 13 μm, 14 μm, 15 μm, 16 μm, 17 μm, 18 μm, 19 μm, or 20 μm. Dv50 of the positive electrode material may be tested by using a laser particle size analyzer. Dv50 refers to a particle size at which a percentage of cumulative volume in particle size distribution of a sample reaches 50%.

When Dv50 of the positive electrode material falls within the foregoing range, a capacity of the battery is improved, press density is improved, energy density of the battery is improved, and room temperature cycling performance and high temperature cycling performance of the battery are improved.

According to an implementation of the present disclosure, a chemical formula of the positive electrode material is Li_{X}Co_{1-y}M_{y}O₂, where 0.9≤x≤1.1, 0≤y≤0.1, and M includes at least one of Al, Mg, Ti, Zr, Co, Ni, Mn, Y, La, Sr, W, Sc, Ta, or Nb.

According to an implementation of the present disclosure, the doping and/or coating method may be a method known in the art, for example, solid-phase sintering is performed after a lithium cobalt oxide precursor is mixed with a compound or a coating including a doped element.

According to an implementation of the present disclosure, a surface of the positive electrode material is coated with a coating, a thickness of a coating layer formed by the coating is less than or equal to 50 nm, and a mass proportion of the coating is less than or equal to 15%, that is, the mass of the coating accounts for 5% or less of a total mass of the positive electrode material, for example, may be 0.5%, 1%, 1.5%, 2%, 2.5%, 3%, 3.5%, 4%, or 5%. The coating includes one or more of Al₂O₃, TiO₂, ZrO₂, MgO, CoO₂, CoO, NiO, MnO₂, Mn₃O₄, NbO₃, Ta₂O₅, AlF₃, MgF₂, AlPO₃, or Li₃PO₃. The surface of the positive electrode material is coated with a coating layer, which can be bonded to transition metal on the surface of the positive electrode material to stabilize the transition metal, reduce side reactions between the transition metal and the electrolyte solution, and improve cycling performance, storage performance, and the like of the battery.

According to an implementation of the present disclosure, the electrolyte solution further includes an organic solvent, and the organic solvent includes one or more of cacrbonic acid ester and/or carboxylic acid ester.

For example, the carbonic acid ester includes one or more of the following fluorinated or unsubstituted solvents: ethylene carbonate, propylene carbonate, dimethyl carbonate, diethyl carbonate, or ethyl methyl carbonate.

For example, the carboxylic acid ester includes one or more of the following fluorinated or unsubstituted solvents: ethyl acetate, propyl acetate, n-butyl acetate, isobutyl acetate, n-amyl acetate, isoamyl acetate, ethyl propionate, propyl propanoate, methyl butyrate, and ethyl butyrate.

According to an implementation of the present disclosure, the nitrile compound includes a dinitrile compound and/or a trinitrile compound. For example, the dinitrile compound includes a group consisting of the following: succinonitrile, glutaronitrile, adiponitrile, 1,5-dicyanopentane, 1,6-dicyanohexane, 1,7-dicyanoheptane, 1,8-diisocyanatooctane, 1,9-dicyanononane, 1,10-dicyanodecane, 1,12-dicyanododecane, tetramethylsuccinonitrile, 2-methylpentanedinitrile, 2,4-dimethylvaleronitrile, 2,2,4,4-tetramethylpentanedinitrile, 1,4-dicyanopentane, 2,6-dicyanoheptane, 2,7-diisocyanatooctane, 2,8-dicyanononane, 1,6-dicyanodecane, 1,2-dicyanobenzene, 1,3-dicyanobenzene, 1,4-dicyanobenzene, 3,5-dioxa-pimelonitrile, 1,4-bis(cyanoethoxy)butane, ethylene glycol bis(2-cyanoethyl)ether, diethylene glycol bis(2-cyanoethyl)ether, triethylene glycol bis(2-cyanoethyl)ether, tetraethylene glycol bis(2-cyanoethyl)ether, 3,6,9,12,15,18-hexaoxaicosane, 1,3-bis(2-cyanoethoxy)propane, 1,4-bis(2-cyanoethoxy)butane, 1,5-bis(2-cyanoethoxy)pentane, ethylene glycol bis(4-cyanobutyl)ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,6-dicyano-2-methyl-5-methyl-3-hexene, and any combination thereof. For example, the trinitrile compound includes a group consisting of the following: 1,3,5-pentane tricarbonitrile, 1,2,3-propane tricarbonitrile, 1,3,6-hexanetricarbonitrile, 1,2,6-hexanetricarbonitrile, 1,2,3-tris(2-cyanoethoxy)propane, 1,2,4-tris(2-cyanoethoxy)butane, 1,1,1-tris(cyanoethoxymethylene)ethane, 1,1,1-tris(cyanoethoxymethylene)propane, 3-methyl-1,3,5-tris(cyanoethoxy)pentane, 1,2,7-tris(cyanoethoxy)heptane, 1,2,6-tris(cyanoethoxy)hexane, 1,2,5-tris(cyanoethoxy)pentane, and any combination thereof.

According to an implementation of the present disclosure, the nitrile compound includes at least one of succinonitrile, glutaronitrile, adiponitrile, pimelonitrile, octandinitril, sebaconitrile, 1,3,6-hexanetricarbonitrile, 3-methoxypropionitrile, glycerol trinitrile, or 1,2-bis(2-cyanoethoxy)ethane.

According to an implementation of the present disclosure, the first additive includes adiponitrile, and the electrolyte solution meets the following relational expression:

$$0.5 \% \leq A \leq 3 \% ;$$

where A is a percentage of a mass of the adiponitrile in the total mass of the electrolyte solution.

According to an implementation of the present disclosure, A is 0.5%, 1%, 1.5%, 2%, 2.5%, or 3%.

According to an implementation of the present disclosure, the electrolyte solution further includes a second additive, and the second additive includes at least one of compounds shown in Formula 1:

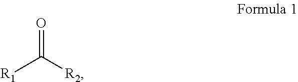

where R₁ and R₂ are the same or different, and are independently selected from a 5- to 12-membered heteroaromatic group.

According to an implementation of the present disclosure, R₁ and R₂ are the same or different, and are independently selected from a 5- to 6-membered heteroaromatic group.

According to an implementation of the present disclosure, R₁ and R₂ are the same or different, and are independently selected from a pyrrolyl group

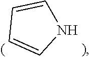

a pyrazolyl group

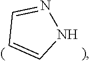

an imidazolyl group

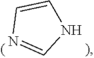

a pyridyl group

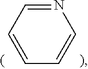

a dazyl group

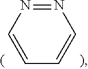

or a pyrimidinyl group

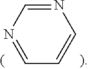

A compound of the second additive may be purchased, or may be obtained by using a conventional preparation method in the art.

According to an implementation of the present disclosure, the second additive includes a compound shown by A1:

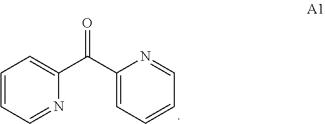 [SMILES: O=C(c1ccccn1)c1ccccn1]

According to an implementation of the present disclosure, a percentage of a mass of the second additive in the total mass of the electrolyte solution ranges from 0.1 wt % to 3 wt %, for example, is 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.2 wt %, 2.4 wt %, 2.5 wt %, 2.6 wt %, 2.8 wt %, or 3 wt %.

According to an implementation of the present disclosure, the electrolyte solution further includes a third additive, and the third additive includes one or more of vinylene carbonate, vinyl ethylene carbonate, fluoroethylene carbonate, ethylene sulphite, methylene methane disulfonate, ethylene sulfate, 1,3-propane sultone, or prop-1-ene-1,3-sultone.

According to an implementation of the present disclosure, a percentage of a mass of the third additive in the total mass of the electrolyte solution ranges from 0.1 wt % to 15.0 wt %, for example, is 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt % 2.2 wt % 2.4 wt % 2.5 wt % 2.6 wt % 2.8 wt % 3 wt % 3.3 wt % 3.5 wt % 3.8 wt % 4 wt % 4.2 wt %, 4.5 wt %, 4.8 wt %, 5 wt %, 6 wt %, 7 wt %, 8 wt %, 9 wt %, 10 wt %, 11 wt %, 12 wt %, 13 wt %, 14 wt %, or 15 wt %.

According to an implementation of the present disclosure, the electrolyte solution further includes lithium salts, and the lithium salts include one, two, or more of lithium hexafluorophosphate, lithium difluorophosphate, lithium difluoro(oxalato)borate, lithium bis(fluorosulfonyl)imide, lithium bis(trifluoromethanesulphonyl)imide, lithium difluorobis(oxalato)phosphate, lithium tetrafluoroborate, lithium bis(oxalate)borate, lithium hexafluoroantimonate, lithium hexafluoroarsenate, lithium bis(trifluoromethylsulfonyl)imine, lithium bis(pentafluoroethylsulfonyl)imine, lithium tris(trifluoromethanesulfonyl)methyl, or lithium bis(trifluoromethyl sulfonyl)imine.

According to an implementation of the present disclosure, a percentage of a mass of the lithium salts in the total mass of the electrolyte solution ranges from 10 wt % to 20 wt %, for example, 10 wt %, 12 wt %, 14 wt %, 15 wt %, 16 wt %, 18 wt %, or 20 wt %. If content of the lithium salts is controlled within the foregoing range, problems such as reduced conductivity of the electrolyte solution, high impedance of the battery, and poor cycling performance due to insufficient addition of lithium salts can be avoided, and problems such as high viscosity of the electrolyte solution, reduced conductivity, poor thermal stability of the battery, and excessive thickness expansion during cycling of the battery due to addition of excessive lithium salts can also be avoided.

According to an implementation of the present disclosure, the battery further includes a separator and a negative electrode plate including a negative electrode material.

According to an implementation of the present disclosure, the negative electrode material includes one or more of a carbon material, metal bismuth, lithium metal, nitride, magnesium-based alloy, indium-based alloy, a boron-based material, a silicon-based material, a tin-based material, an antimony-based alloy, a gallium-based alloy, a germanium-based alloy, an aluminum-based alloy, a lead-based alloy, a zinc-based alloy, titanium oxide, and nano-transition metal oxide (where M is Co, Ni, Cu, or Fe), iron oxide, chromium oxide, molybdenum oxide, and phosphide.

According to an implementation of the present disclosure, an operation cut-off voltage of the battery is greater than or equal to 4.48 V.

When the positive electrode material provided in the present disclosure meets 1.3≤I₀₀₃/I₁₀₄≤3, 0.02≤I₀₀₆/I₀₀₃≤0.15, and 0.06≤I₀₀₆/I₁₀₄≤0.15, the positive electrode material has high crystallization integrity, a layered structure thereof has good stability, and a high degree of order is achieved in terms of the ion arrangement of cations (for example, lithium ions and cobalt ions). The positive electrode material has high structural stability and a relatively stable interface under high-voltage and full-electricity conditions. In addition, the battery in the present disclosure can operate at a high voltage.

Experimental methods used in the following examples are all conventional methods, unless otherwise specified. Reagents, materials, and the like used in the following examples are all commercially available, unless otherwise specified.

### Comparative Example 1

### (1) Preparation of Positive Electrode Plates

(i) Weighing lithium carbonate and Co₃O₄ precursors according to a molar ratio of Li:Co=103:99.5, calcining the lithium carbonate and Co₃O₄ precursors in a muffle furnace at 1030° C. for 8 hours, and pulverizing the calcined product to obtain LiCoO₂ with particle Dv50 being 15.5 m.

(ii) Uniformly mixing prepared lithium cobalt oxide with titanium dioxide according to a molar ratio of Co:Ti=98.8:0.2 by stirring, calcining the mixture in a muffle furnace at 900° C. for 8 hours, and pulverizing the calcined product to obtain a positive electrode active material Li_{1.03}Co_{0.988}Ti_{0.002}O₂ of the lithium cobalt oxide.

The foregoing positive electrode material Li_{1.03}Co_{0.988}Ti_{0.002}O₂, a binder, that is, polyvinylidene fluoride (PVDF), and a conductive agent, that is, acetylene black were mixed at a weight ratio 98:1.5:0.5, and added into N-methylpyrrolidone (NMP). The mixture was stirred under action of a vacuum mixer until a mixed system became a uniform and liquid positive electrode slurry. The positive electrode slurry was evenly coated on aluminum foil with a thickness of 12 μm. The coated aluminum foil was baked in an oven with five different temperatures, and was dried in an oven at 120° C. for 8 hours, followed by roll-pressing and cutting, to obtain a positive electrode plate.

### (2) Preparation of Negative an Electrode Plate

A negative electrode active material graphite, a thickener, that is, sodium carboxymethyl cellulose (CMC-Na), a binder, that is, styrene-butadiene rubber, and a conductive agent, that is, acetylene black, were mixed at a weight ratio of 97:1:1:1, and added into deionized water. The mixture was stirred under action of a vacuum mixer to obtain a negative electrode slurry. The negative electrode slurry was evenly coated on copper foil with a thickness of 8 μm. The copper foil was dried at room temperature, and then transferred to an oven and dried at 80° C. for 10 hours, followed by cold pressing and cutting, to obtain a negative electrode plate.

### (3) Preparation of an Electrolyte Solution

Ethylene carbonate, propylene carbonate, and propyl propanoate were evenly mixed at a mass ratio of 15:10:75 in a glove box filled with argon gas and with a qualified water content and oxygen content (a solvent and an additive should be normalized together), the solvent was frozen at low temperature of about −10° C. for 2 hours to 5 hours, and then quickly added with fully dried lithium hexafluorophosphate (LiPF6) of 14.5 wt %. The mixture was evenly stirred, added with fluoroethylene carbonate of 7 wt %, 1,3-propane sultone of 3.5 wt %, succinonitrile of 1.5 wt %, and glycerol trinitrile of 2.5 wt %, and then were stirred again until uniform. The electrolyte solution in Comparative Example 1 was obtained after passing water content and free acid tests.

### (4) Preparation of a Separator

A polyethylene separator with a thickness of 8 μm was used (from AsahiKASEI Corporation).

### (5) Preparation of a Lithium-Ion Battery

The positive electrode plate, the separator, and the negative electrode plate prepared above were sequentially stacked, to ensure that the separator was located between the positive electrode plate and the negative electrode plate for separation. Then, winding was performed to obtain an unfilled bare cell. The bare cell was placed in outer packaging foil. The electrolyte solution prepared above was injected into the dried bare cell. After processes such as vacuum packaging, standing, forming, shaping, and sorting, the required lithium-ion battery was obtained.

### (6) Test of XRD of Powders of a Positive Electrode Material

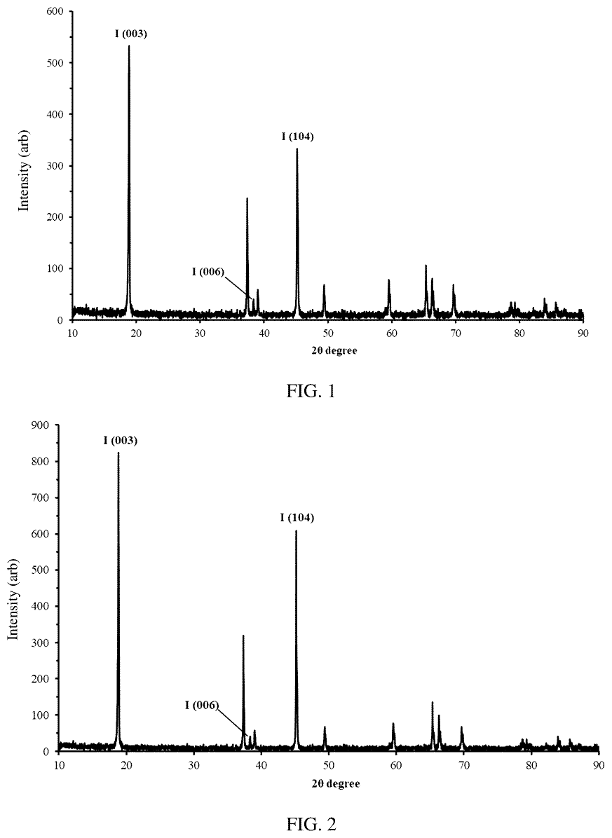

Positive material sample powders were taken, and XRD of the powders was tested (as shown in FIG. 1, a horizontal coordinate 2θ degree means a 2θ angle). Based on intensity of corresponding diffraction peaks, ratios among intensity of I₀₀₃ peak, I₁₀₄ peak, and I₀₀₆ peak were separately calculated. A test result indicates intensity of diffraction peaks I₀₀₃, I₁₀₄, and I₀₀₆ meets the following: I₀₀₃/I₁₀₄=1.2, I₀₀₆/I₀₀₃=0.015, and I₀₀₆/I₁₀₄=0.018. A voltage system of a corresponding battery is 4.48 V.

### (7) 25° C. Normal Temperature Cycling Test

Before the test, a thickness Do of a fully charged cell was measured. A battery is placed in an environment of (25±3)° C. for 3 hours. When a cell body reached (25±3)° C., the battery was first charged to 4.2 V at 1C, then charged to 4.48 V at 0.7C, and then charged at a constant voltage of 4.48 V to a cut-off current of 0.05C. After that, the battery was discharged to 3 V at 0.5C, and an initial capacity Q₀ was recorded. When cycles reached a required number of times, a discharge capacity obtained in this case was used as a capacity Q₂ of the battery to calculate a capacity retention rate (%). After that, the battery was fully charged and then the cell was taken out and was stood in normal temperature for 3 hours, to measure a thickness D₂ in a fully charged state, and calculate a thickness change rate (%). The results are shown in Table 2. Calculation formulas used are as follows.

$$Thickness change rate ( \% ) = ( {D}_{2} - {D}_{0} ) / {D}_{0} \times 100 \% and Capacity retention rate ( \% ) = {Q}_{2} / {Q}_{0} \times 100 \% .$$

### (8) 45° C. High Temperature Cycling Test

Before the test, a thickness Do of a fully charged cell was measured. A battery is placed in an environment of (45±3)° C. for 3 hours. When a cell body reached (45±3)° C., the battery was charged to 4.48 V at a constant current of 0.7C, and then charged at a constant voltage of 4.48 V to a cut-off current of 0.05C. After that, the battery was discharged at 0.5C, and an initial capacity Q₀ was recorded. The cycle was repeated in this way. When cycles reached a required number of times, a discharge capacity obtained in this case was used as a capacity Q₃ of the battery to calculate a capacity retention rate (%). After that, the battery was fully charged and then the cell was taken out and was stood in normal temperature for 3 hours, to measure a thickness D3 in a fully charged state, and calculate a thickness change rate (%). The results are shown in Table 2. Calculation formulas used are as follows.

$$Thickness change rate ( \% ) = ( {D}_{3} - {D}_{0} ) / {D}_{0} \times 100 \% ; and Capacity retention rate ( \% ) = {Q}_{3} / {Q}_{0} \times 100 \% .$$

### (9) 60° C. High Temperature Storage Test

A thickness Do of a fully charged cell was measured at 25° C. A battery obtained after sorting was charged to 4.48 V at 0.7C, then charged at a constant voltage of 4.48 V to a cut-off current of 0.05C, and then discharged to 3.0 V at a constant current of 0.5C. After that, the battery is charged to 4.48 V at 0.7C, and charged at a constant voltage of 4.48 V to a cut-off current of 0.05C. After the battery was stood in an environment of 60° C. for 35 days, a thickness D₅ in a fully charged state was measured, and a thickness change rate (%) was calculated. The results are shown in Table 2. A calculation formula used is as follows: Thickness change rate (%)=(D₅−D₀)/D₀×100%.

(10) Hot box test

At 25° C., a battery was charged to 4.2 V at 1C, then charged to 4.48 V at 0.7C, and then charged at a constant voltage of 4.48 V to a cut-off current of 0.05C. The battery was placed in a hot box, and a temperature was increased to 132° C. at a rate of 5±2° C./min, and was kept in 132° C. for 60 min. If the battery is not on fire and is not exploded, the hot box test succeeds.

### Examples 1 to 7 and Comparative Examples 2 to 8

Processes for preparing the battery in Examples 1 to 7 and Comparative Examples 2 to 8 are the same as that in Comparative Example 1. Differences lie in composition of positive electrode materials, differences in terms of modified processes, and differences in terms of components and content of electrolyte solutions. This is specifically as follows.

Method for preparing a positive electrode material in Example 1.

(i) Weighing lithium carbonate and Co₃O₄ precursors according to a molar ratio of Li:Co=103:99.5, weighing aluminum oxide and magnesium oxide according to a molar ratio of Co:Al:Mg=98.8:1:0.2, uniformly mixing them by stirring, calcining the mixture in a muffle furnace at 1030° C. for 8 hours, and pulverizing the calcined product to obtain LiCo_{0.988}Al_{0.01}Mg_{0.002}O₂ with particle Dv50 being 15.5 μm.

(ii) Uniformly mixing LiCo_{0.988}Al_{0.01}Mg_{0.002}O₂ with titanium dioxide according to a molar ratio of Co:Ti=98.6:0.2 by stirring, calcining the mixture in a muffle furnace at 900° C. for 8 hours, and pulverizing the calcined product to obtain a positive electrode active material Li_{1.03}Co_{0.986}Al_{0.01}Mg_{0.002}Ti_{0.002}O₂ of lithium cobalt oxide. An XRD spectra is shown in FIG. 2.

Method for preparing a positive electrode material in Example 2.

The method for preparing a positive electrode material in Example 2 is the same as that in Example 1, and a difference lies in that calcining time in step (i) is 9 hours.

Method for preparing a positive electrode material in Example 3.

The method for preparing a positive electrode material in Example 3 is the same as that in Example 1, and a difference lies in that calcining temperature in step (i) is 1050° C. and calcining time is 10 hours.

Method for preparing a positive electrode material in Example 8.

The method for preparing a positive electrode material in Example 8 is the same as that in Example 1, and a difference lies in that a coating Al₂O₃ is coated on a surface of the positive electrode material, a thickness of a coating layer formed by the coating is approximately 30 nm, and a mass proportion of the coating is approximately 3%.

### Example 9

Same as Example 7. A difference lies in that a compound

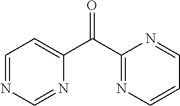 [SMILES: O=C(c1ccncn1)c1ncccn1]

of an equal quantity instead of the compound shown by A1 is used as the second additive in the electrolyte solution.

### Example 10

Same as Example 7. A difference lies in that a compound

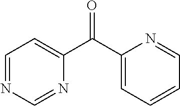 [SMILES: O=C(c1ccccn1)c1ccncn1]

of an equal quantity instead of the compound shown by A1 is used as the second additive in the electrolyte solution.

### Example 11

Same as Example 7. A difference lies in that the third additive in the electrolyte solution is vinylene carbonate of 7 wt %, ethylene sulfate of 2.5 wt %, and prop-1-ene-1,3-sultone of 1 wt %.

### Example 12

Same as Example 7. A difference lies in that the third additive in the electrolyte solution is fluoroethylene carbonate of 9 wt % and 1,3-propane sultone of 4 wt %.

Method for preparing a positive electrode material in Comparative Example 2.

The method for preparing a positive electrode material in Comparative Example 2 is the same as that in Comparative Example 1, and a difference lies in that calcining time in step (i) is 10 hours.

Method for preparing a positive electrode material in Comparative Example 3.

The method for preparing a positive electrode material in Comparative Example 3 is the same as that in Comparative Example 1, and a difference lies in that calcining temperature in step (i) is 1040° C. and calcining time is 8.5 hours.

Specific composition of positive electrode materials with different diffraction peaks and electrolyte solutions is shown in the following table 1. The test results are listed in Table 2.

TABLE 1
Composition and content of the positive electrode material and the electrolyte solution of
Examples 1 to 20 and Comparative Examples 1 to 8

| | | | | | | | 1,3,6- | |
|---|---|---|---|---|---|---|---|---|
| | | | | | | Glycerol | hexanetri- | Compound |
| | I₀₀₃/I₁₀₄ | I₀₀₆/I₀₀₃ | I₀₀₆/I₁₀₄ | Succinonitrile | Adiponitrile | trinitrile | carbonitrile | shown by A1 |
| Comparative | 1.200 | 0.015 | 0.018 | 1.5 | / | 2.5 | / | / |
| Example 1 | | | | | | | | |
| Comparative | 1.532 | 0.030 | 0.046 | 1.5 | / | 2.5 | / | / |
| Example 2 | | | | | | | | |
| Comparative | 1.254 | 0.045 | 0.056 | 1.5 | / | 2.5 | / | / |
| Example 3 | | | | | | | | |
| Comparative | 1.200 | 0.015 | 0.018 | 1.5 | 1 | 2.5 | / | / |
| Example 4 | | | | | | | | |
| Comparative | 1.200 | 0.015 | 0.018 | 1.5 | 1 | / | 2.5 | / |
| Example 5 | | | | | | | | |
| Comparative | 1.200 | 0.015 | 0.018 | 1.5 | 1 | 2.5 | / | 0.5 |
| Example 6 | | | | | | | | |
| Comparative | 1.352 | 0.051 | 0.069 | 1.5 | / | 1 | / | / |
| Example 7 | | | | | | | | |
| Comparative | 1.352 | 0.051 | 0.069 | 1.5 | 2 | 3.5 | / | / |
| Example 8 | | | | | | | | |
| Example 1 | 1.352 | 0.051 | 0.069 | 1.5 | / | 2.5 | / | / |
| Example 2 | 1.561 | 0.043 | 0.067 | 1.5 | / | 2.5 | / | / |
| Example 3 | 2.012 | 0.065 | 0.131 | 1.5 | / | 2.5 | / | / |
| Example 4 | 1.352 | 0.051 | 0.069 | 1.5 | 1 | 2.5 | / | / |
| Example 5 | 1.352 | 0.051 | 0.069 | 1.5 | 2 | 2.5 | / | / |
| Example 6 | 1.352 | 0.051 | 0.069 | 1.5 | 1 | / | 2.5 | / |
| Example 7 | 1.352 | 0.051 | 0.069 | 1.5 | 1 | 2.5 | / | 0.5 |
| Example 13 | 1.352 | 0.051 | 0.069 | 1 | 0.5 | 2 | 1.5 | 0.5 |
| Example 14 | 1.352 | 0.051 | 0.069 | 0.5 | 3 | 1 | 0.5 | 0.5 |
| Example 15 | 1.352 | 0.051 | 0.069 | 2 | 0.1 | 2.5 | 0.4 | 0.5 |
| Example 16 | 1.352 | 0.051 | 0.069 | 0 | 5 | 0 | 0 | 0.5 |
| Example 17 | 1.352 | 0.051 | 0.069 | 1.5 | 1 | 2.5 | / | 0.1 |
| Example 18 | 1.352 | 0.051 | 0.069 | 1.5 | 1 | 2.5 | / | 3 |
| Example 19 | 1.352 | 0.051 | 0.069 | 1.5 | 1 | 2.5 | / | 2 |
| Example 20 | 1.352 | 0.051 | 0.069 | 1.5 | 1 | 2.5 | / | 5 |

It can be learned from Table 2 that, all batteries prepared in the examples of the present disclosure achieve better electrical performance. Test results from the hot box test for the battery, an amplitude of improvements to a capacity retention rate and a thickness expansion rate of the cycling performance, and a storage process can prove a synergistic effect between a lithium cobalt oxide positive electrode using a complete crystalline structure and the electrolyte solution in the present disclosure. Specific analysis is described as follows.

TABLE 2
Comparison between experimental results of batteries in Examples 1 to 20 and
Comparative Examples 1 to 8

| | | Capacity | Thickness | Capacity | Thickness | Thickness |
|---|---|---|---|---|---|---|
| | | retention rate at | expansion rate | retention rate at | expansion rate | expansion rate |
| | | 25° C. after | at 25° C. after | 45° C. after | at 45° C. after | at 60° C. after |
| | 132° C. 60 min | 800 T of cycles | 800 T of cycles | 500 T of cycles | 500 T of cycles | 35 D of storage |
| Comparative | 2/10 PASS | 75.31% | 9.78% | 76.22% | 11.46% | 9.52% |
| Example 1 | | | | | | |
| Comparative | 3/10 PASS | 76.45% | 9.65% | 78.35% | 9.86% | 8.73% |
| Example 2 | | | | | | |
| Comparative | 2/10 PASS | 76.37% | 9.59% | 81.34% | 9.78% | 8.36% |
| Example 3 | | | | | | |
| Comparative | 4/10 PASS | 75.63% | 9.73% | 78.92% | 9.82% | 8.21% |
| Example 4 | | | | | | |
| Comparative | 4/10 PASS | 75.78% | 9.70% | 79.32% | 9.75% | 8.07% |
| Example 5 | | | | | | |
| Comparative | 5/10 PASS | 77.33% | 9.68% | 79.82% | 9.67% | 7.83% |
| Example 6 | | | | | | |
| Comparative | 1/10 PASS | 79.63% | 9.48% | 70.21% | 13.83% | 13.82% |
| Example 7 | | | | | | |
| Comparative | 6/10 PASS | 73.02% | 11.39% | 85.63% | 8.56% | 4.63% |
| Example 8 | | | | | | |
| Example 1 | 6/10 PASS | 79.45% | 9.63% | 82.42% | 9.16% | 6.36% |
| Example 2 | 7/10 PASS | 79.69% | 9.51% | 81.62% | 9.36% | 7.52% |
| Example 3 | 7/10 PASS | 79.85% | 9.24% | 84.45% | 9.03% | 5.73% |
| Example 4 | 8/10 PASS | 79.25% | 9.71% | 84.64% | 8.75% | 5.32% |
| Example 5 | 9/10 PASS | 79.18% | 9.76% | 85.75% | 8.42% | 5.20% |
| Example 6 | 9/10 PASS | 79.65% | 9.68% | 84.86% | 8.72% | 5.18% |
| Example 7 | 9/10 PASS | 81.47% | 9.45% | 85.89% | 8.52% | 4.87% |
| Example 8 | 8/10 PASS | 79.66% | 9.46% | 83.85% | 8.73% | 5.13% |
| Example 9 | 8/10 PASS | 81.41% | 9.38% | 85.96% | 8.40% | 5.05% |
| Example 10 | 9/10 PASS | 81.52% | 9.26% | 86.18% | 8.31% | 4.72% |
| Example 11 | 10/10 PASS | 81.28% | 9.52% | 84.81% | 8.63% | 5.31% |
| Example 12 | 8/10 PASS | 83.24% | 9.12% | 86.97% | 8.35% | 4.53% |
| Example 13 | 7/10 PASS | 82.93% | 9.10% | 85.45% | 8.42% | 5.11% |
| Example 14 | 8/10 PASS | 81.02% | 9.23% | 83.53% | 8.51% | 5.53% |
| Example 15 | 7/10 PASS | 81.46% | 9.41% | 83.42% | 8.62% | 5.26% |
| Example 16 | 8/10 PASS | 80.02% | 9.47% | 82.34% | 9.04% | 7.56% |
| Example 17 | 8/10 PASS | 80.26% | 9.44% | 85.27% | 8.63% | 5.15% |
| Example 18 | 10/10 PASS | 81.43% | 9.43% | 86.37% | 8.33% | 4.53% |
| Example 19 | 9/10 PASS | 81.56% | 9.37% | 86.21% | 8.48% | 4.61% |
| Example 20 | 10/10 PASS | 79.71% | 9.46% | 87.32% | 8.21% | 4.31% |

It can be found through comparison between Examples 1 to 3 and Comparative Examples 1 to 3 (or Example 6 and Comparative Example 5, or Example 7 and Comparative Example 6) that: when the intensity of I₀₀₃, I₁₀₄, and I₀₀₆ diffraction peaks of the positive electrode material meets 1.3≤I₀₀₃/I₁₀₄≤3, 0.02≤I₀₀₆/I₀₀₃≤0.15, and 0.06≤I₀₀₆/I₁₀₄≤0.15, and total content B of nitrile compounds meets 3%≤B≤6%, the battery has an excellent hot box pass rate, excellent normal/high temperature cycling performance, and 60° C. storage performance; and when I₀₀₆/I₁₀₄ is properly increased within a prescribed range, 45° C. high temperature cycling performance of the battery can be significantly improved. It can be found through comparison between Comparative Example 4 and Comparative Example 1 that the additive adiponitrile in the electrolyte solution can significantly improve the hot box pass rate of the battery and can further improve 45° C. cycling performance and 60° C. high temperature storage performance.

It can be found through Examples 4 and 5 and Example 1 that when the intensity of I₀₀₃, I₁₀₄, and I₀₀₆ diffraction peaks of the positive electrode material meets 1.3≤I₀₀₃/I₁₀₄≤3, 0.02≤I₀₀₆/I₀₀₃≤0.15, and 0.06≤I₀₀₆/I₁₀₄≤0.15, adiponitrile is added to the electrolyte solution, and content A of the adiponitrile and total content B of nitrile compounds meet 0.5%≤A≤3% and 3%≤B≤6%, so that the hot box pass rate, cycling performance, and 60° C. high temperature storage performance of the battery can be further improved.

It can be found through comparison between Example 1 and Comparative Example 7 that, when the intensity of I₀₀₃, I₁₀₄, and I₀₀₆ diffraction peaks of the positive electrode material meets 1.3≤I₀₀₃/I₁₀₄≤3, 0.02≤I₀₀₆/I₀₀₃≤0.15, and 0.06≤I₀₀₆/I₁₀₄≤0.15, when the total content B of the nitrile compounds in the electrolyte solution is ≤3%, the hot box pass rate, 45° C. high temperature cycling performance, and 60° C. high temperature storage performance of the battery significantly deteriorate.

It can be found through comparison between Examples 1, 4, and 5 and Comparative Example 8 that when the intensity of I₀₀₃, I₁₀₄, and I₀₀₆ diffraction peaks of the positive electrode material meets 1.3≤I₀₀₃/I₁₀₄≤3, 0.02≤I₀₀₆/I₀₀₃≤0.15, and 0.06≤I₀₀₆/I₁₀₄≤0.15, when the total content B of the nitrile compounds in the electrolyte solution is >6%, normal temperature cycling performance and storage performance of the battery significantly deteriorate.

It can be found through comparison between Examples 7 and 4 and Comparative Examples 6 and 4 that, when the second additive is added to the electrolyte solution, the hot box pass rate, cycling performance, and 60° C. high temperature storage performance of the battery can be further improved.

The foregoing describes the implementations of the present disclosure. However, the present disclosure is not limited to the foregoing implementations. Any modification, equivalent replacement, improvement, or the like made without departing from the spirit and the principle of the present disclosure shall fall within the protection scope of the present disclosure.

What is claimed is:

1. A battery, comprising a positive electrode plate, wherein the positive electrode plate comprises a positive electrode material, and the positive electrode material meets the following relationships:
$$1.3 \leq {I}_{003} / {I}_{104} \leq 3 , 0.02 \leq {I}_{006} / {I}_{003} \leq 0.15 , and 0.06 \leq {I}_{006} / {I}_{104} \leq 0.15 ,$$
wherein I₀₀₃ is intensity of a characteristic diffraction peak of a (003) crystal plane that is obtained from an XRD diffraction peak of a powder sample of the positive electrode material, I₁₀₄ is intensity of a characteristic diffraction peak of a (104) crystal plane that is obtained from the XRD diffraction peak of the powder sample of the positive electrode material, and I₀₀₆ is intensity of a characteristic diffraction peak of a (006) crystal plane that is obtained from the XRD diffraction peak of the powder sample of the positive electrode material; and
the battery comprises an electrolyte solution, the electrolyte solution comprises a first additive, the first additive comprises a nitrile compound, and the electrolyte solution meets the following relational expression:
$$3 \% \leq B \leq 6 \% ,$$
wherein B is a percentage of a mass of the nitrile compound in a total mass of the electrolyte solution.

2. The battery according to claim 1, wherein Dv50 of the positive electrode material ranges from 12 μm to 20 μm.

3. The battery according to claim 1, wherein a chemical formula of the positive electrode material is Li_{X}Co_{1-y}M_{y}O₂, wherein 0.9≤x≤1.1, 0≤y≤0.1, and M comprises at least one of Al, Mg, Ti, Zr, Co, Ni, Mn, Y, La, Sr, W, Sc, Ta, or Nb.

4. The battery according to claim 1, wherein a surface of the positive electrode material is coated with a coating, a thickness of a coating layer formed by the coating is less than or equal to 50 nm, and the mass of the coating accounts for 5% or less of a total mass of the positive electrode material; and/or
the coating comprises one or more of Al₂O₃, TiO₂, ZrO₂, MgO, CoO₂, CoO, NiO, MnO₂, Mn₃O₄, NbO₃, Ta₂O₅, AlF₃, MgF₂, AlPO₃, or Li₃PO₃.

5. The battery according to claim 1, wherein the nitrile compound comprises a dinitrile compound and/or a trinitrile compound.

6. The battery according to claim 1, wherein the nitrile compound comprises at least one of succinonitrile, glutaronitrile, adiponitrile, pimelonitrile, octandinitril, sebaconitrile, 1,3,6-hexanetricarbonitrile, 3-methoxypropionitrile, glycerol trinitrile, or 1,2-bis(2-cyanoethoxy)ethane.

7. The battery according to claim 1, wherein the first additive comprises adiponitrile, and the electrolyte solution meets the following relational expression:
$$0.5 \% \leq A \leq 3 \% ,$$
wherein A is a percentage of a mass of the adiponitrile in the total mass of the electrolyte solution.

8. The battery according to claim 1, wherein the electrolyte solution further comprises a second additive, and the second additive comprises at least one of compounds shown in Formula 1: 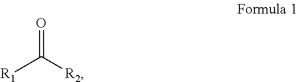
wherein R₁ and R₂ are the same or different, and are independently selected from a 5- to 12-membered heteroaromatic group.

9. The battery according to claim 8, wherein R₁ and R₂ are the same or different, and are independently selected from a 5- to 6-membered heteroaromatic group.

10. The battery according to claim 8, wherein R₁ and R₂ are the same or different, and are independently selected from a pyrrolyl group, a pyrazolyl group, an imidazolyl group, a pyridyl group, a dazyl group, or a pyrimidinyl group.

11. The battery according to claim 8, wherein the second additive comprises a compound shown by A1:

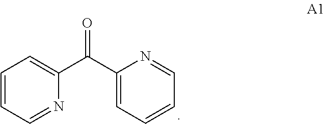 [SMILES: O=C(c1ccccn1)c1ccccn1]

12. The battery according to claim 8, wherein a percentage of a mass of the second additive in the total mass of the electrolyte solution ranges from 0.1 wt % to 3 wt %.

13. The battery according to claim 1, wherein the electrolyte solution further comprises a third additive, and the third additive comprises one or more of vinylene carbonate, vinyl ethylene carbonate, fluoroethylene carbonate, ethylene sulphite, methylene methane disulfonate, ethylene sulfate, 1,3-propane sultone, or prop-1-ene-1,3-sultone; and/or
a percentage of a mass of the third additive in the total mass of the electrolyte solution ranges from 0.1 wt % to 15.0 wt %.

14. The battery according to claim 1, wherein the electrolyte solution further comprises lithium salts, and a percentage of a mass of the lithium salts in the total mass of the electrolyte solution ranges from 10 wt % to 20 wt %.

15. The battery according to claim 1, wherein an operation cut-off voltage of the battery is greater than or equal to 4.48 V.

16. The battery according to claim 1, wherein the positive electrode material meets the following relationships:
$$1.6 \leq {I}_{003} / {I}_{104} \leq 3 , 0.055 \leq {I}_{006} / {I}_{003} \leq 0.15 , and 0.1 \leq {I}_{006} / {I}_{104} \leq 0.15 .$$

17. The battery according to claim 1, wherein the electrolyte solution further comprises an organic solvent, and the organic solvent comprises carbonic acid ester and/or carboxylic acid ester.

18. The battery according to claim 5, wherein the dinitrile compound comprises a group consisting of the following: succinonitrile, glutaronitrile, adiponitrile, 1,5-dicyanopentane, 1,6-dicyanohexane, 1,7-dicyanoheptane, 1,8-diisocyanatooctane, 1,9-dicyanononane, 1,10-dicyanodecane, 1,12-dicyanododecane, tetramethylsuccinonitrile, 2-methylpentanedinitrile, 2,4-dimethylvaleronitrile, 2,2,4,4-tetramethylpentanedinitrile, 1,4-dicyanopentane, 2,6-dicyanoheptane, 2,7-diisocyanatooctane, 2,8-dicyanononane, 1,6-dicyanodecane, 1,2-dicyanobenzene, 1,3-dicyanobenzene, 1,4-dicyanobenzene, 3,5-dioxa-pimelonitrile, 1,4-bis(cyanoethoxy)butane, ethylene glycol bis(2-cyanoethyl)ether, diethylene glycol bis(2-cyanoethyl)ether, triethylene glycol bis(2-cyanoethyl)ether, tetraethylene glycol bis(2-cyanoethyl)ether, 3,6,9,12,15,18-hexaoxaicosane, 1,3-bis(2-cyanoethoxy)propane, 1,4-bis(2-cyanoethoxy)butane, 1,5-bis(2-cyanoethoxy)pentane, ethylene glycol bis(4-cyanobutyl)ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,6-dicyano-2-methyl-5-methyl-3-hexene, and/or
the trinitrile compound comprises a group consisting of the following: 1,3,5-pentane tricarbonitrile, 1,2,3-propane tricarbonitrile, 1,3,6-hexanetricarbonitrile, 1,2,6-hexanetricarbonitrile, 1,2,3-tris(2-cyanoethoxy)propane, 1,2,4-tris(2-cyanoethoxy)butane, 1,1,1-tris(cyanoethoxymethylene)ethane, 1,1,1-tris(cyanoethoxymethylene)propane, 3-methyl-1,3,5-tris(cyanoethoxy)pentane, 1,2,7-tris(cyanoethoxy)heptane, 1,2,6-tris(cyanoethoxy)hexane, 1,2,5-tris(cyanoethoxy)pentane.

19. The battery according to claim 1, wherein the battery further comprises a separator and a negative electrode plate comprising a negative electrode material.

20. The battery according to claim 19, wherein the negative electrode material comprises at least one of a carbon material, metal bismuth, lithium metal, nitride, magnesium-based alloy, indium-based alloy, a boron-based material, a silicon-based material, a tin-based material, an antimony-based alloy, a gallium-based alloy, a germanium-based alloy, an aluminum-based alloy, a lead-based alloy, a zinc-based alloy, titanium oxide, and nano-transition metal oxide, iron oxide, chromium oxide, molybdenum oxide, and phosphide; and a transition metal of nano-transition metal oxide is Co, Ni, Cu, or Fe.
